(19) United States
(12) Patent Application Publication
(10) Pub. No.: US 2003/0145809 A1
(43) Pub. Date: Aug. 7, 2003

(54) Internal combustion engine

(76) Inventor: Timo Tapani Janhunen, Monninkyla (FI)

Correspondence Address: JOEL D. SKINNER, JR., SKINNER AND ASSOCIATES, 212 COMMERCIAL ST., HUDSON, WI, 54016, US

(21) Appl. No.: 10/221,092

(22) PCT Filed: Feb. 23, 2001
(86) PCT No.: PCT/FI01/00187

(30) Foreign Application Priority Data
Mar. 6, 2000 (FI) 20000506

(51) Int. Cl. F02B 75/02

(52) U.S. Cl. 123/65 VD

(57) ABSTRACT

The invention deals with a new type of combustion engine, Z4-engine. It has an insulated compressor part and a work part. The temperature of the compressed gas can be controlled, for example cool. The new gas shall be transferred over the piston during a small crank angle, when the piston closes the top gear centre. The fuel shall be injected to the hot air. After the gas exchange, before the top dead centre, occurs the secondary compression of the gas, the self ignition of the mixture or the ignition. The exhaust gases exit the cylinder through the exhaust valve. The delivery rate of the compressor can be different from the stroke volume of the working pistons together. The side force of the piston can be removed by means of a twin crank mechanism. Also a normal crank mechanism is possible, thus the insulated compressor part can be for example a screw compressor.

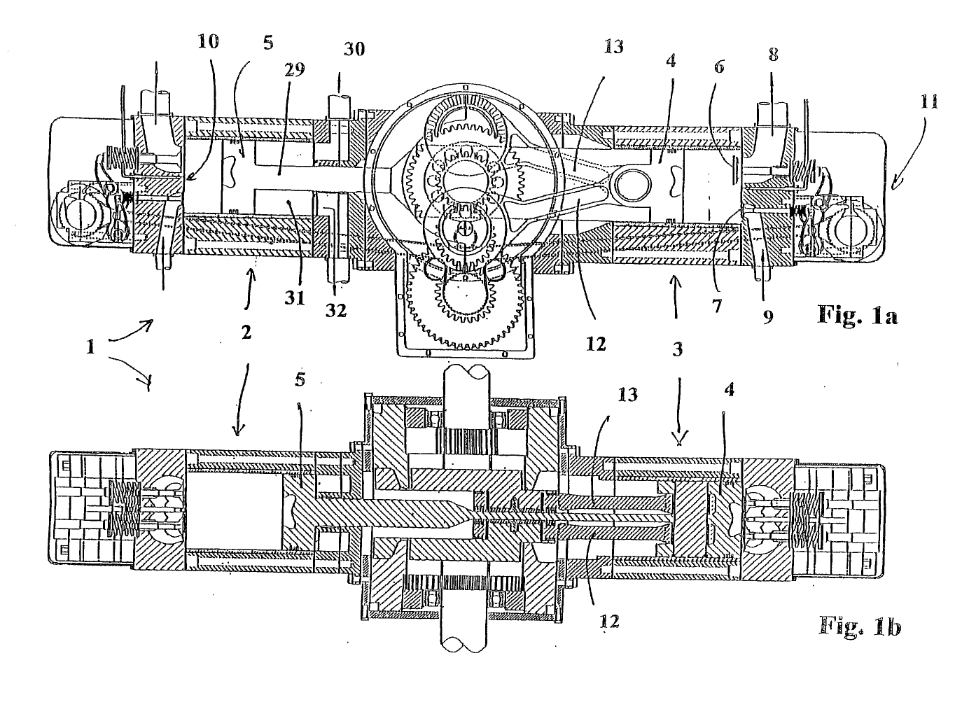

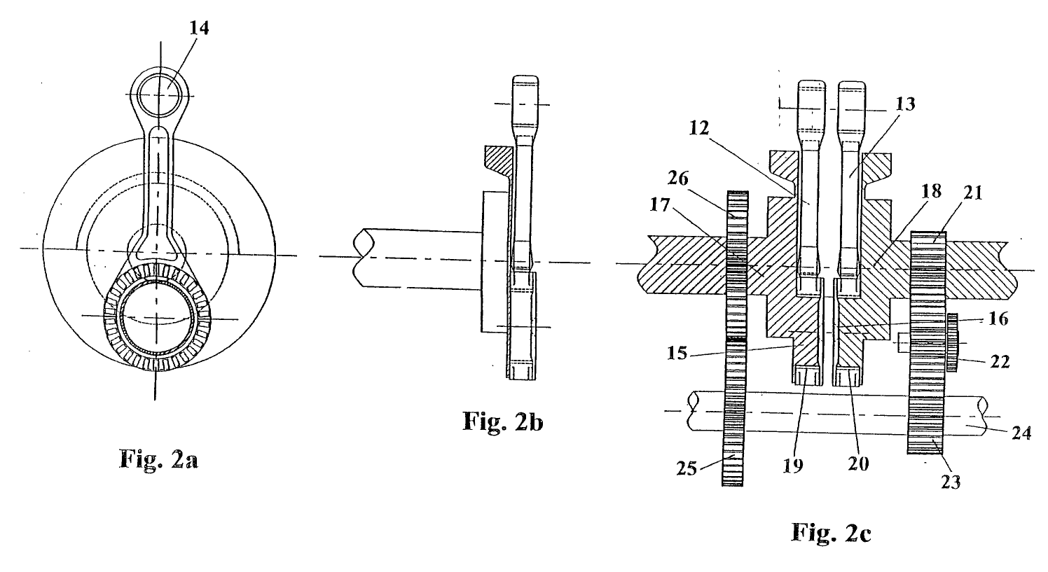

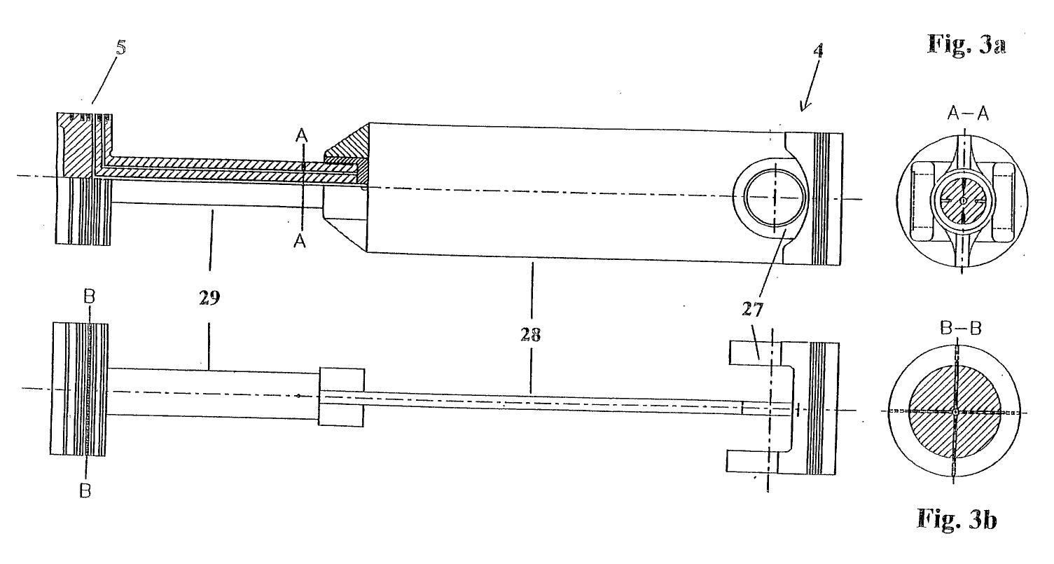

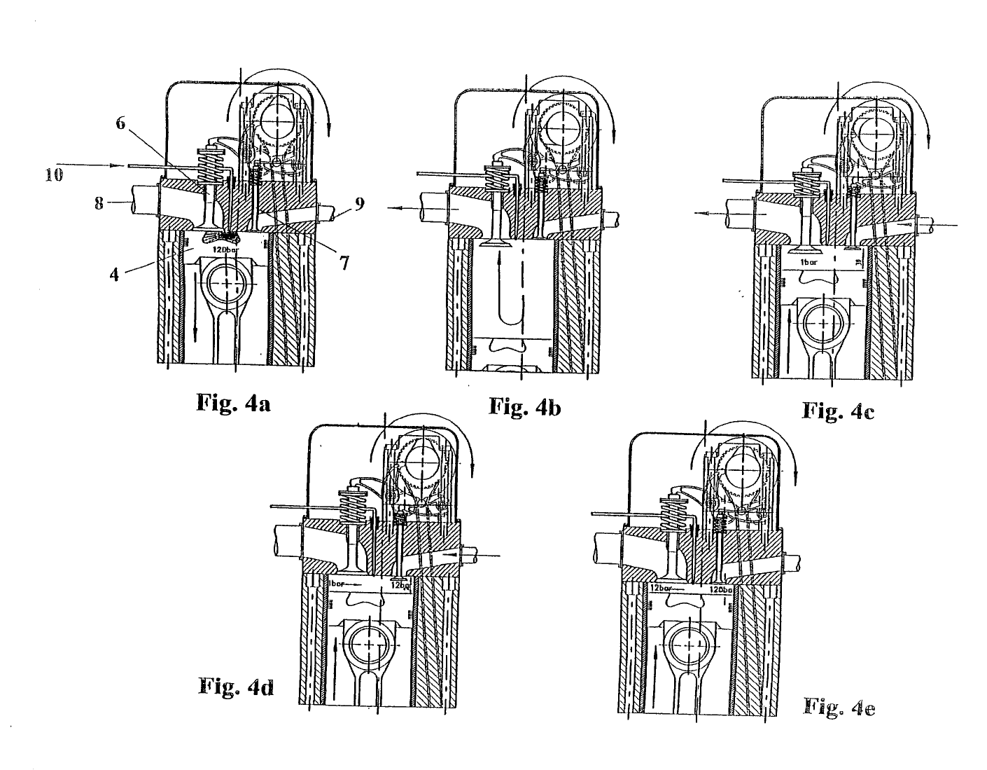

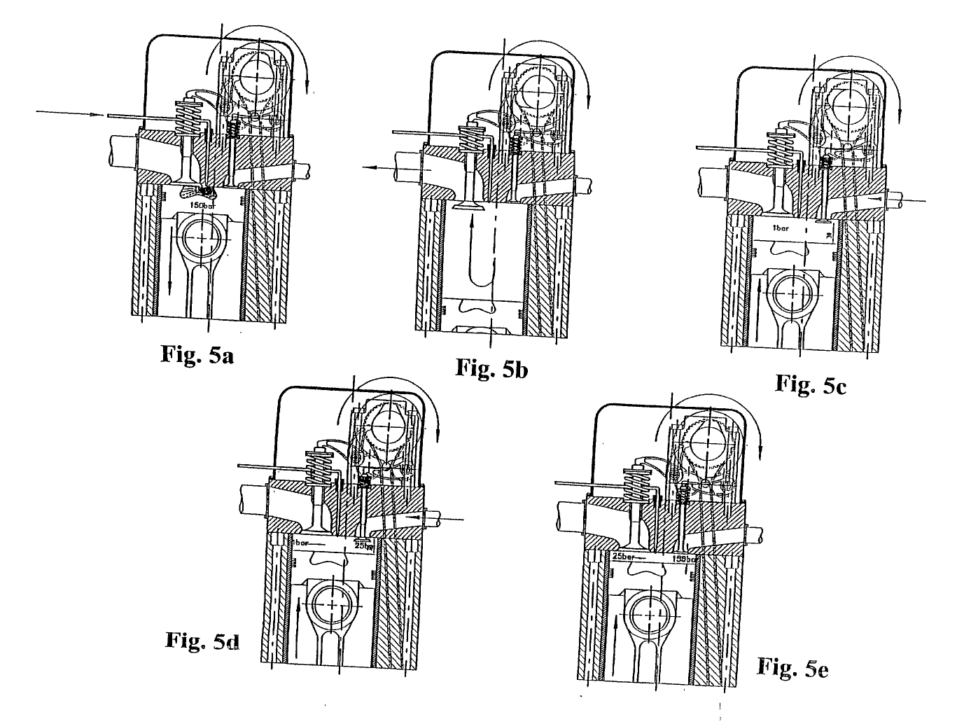

The present 4-stroke engines produce power only at each second rotation of the crankshaft. This increases the size of the engine and the mechanical loses. The increase of the compression ration in a diesel engine improves the efficiency but rises also the compression temperature and thus the temperature during the combustion. This means that the thermal losses and the amount of the nitrogen oxides, NOx increase.

The disadvantages of the present combustion engines has been tried to remove by means of many new innovations. The U.S. Pat. No. 5,285,752 deals with for instance the removing of the side force of the piston, it has a compressor par in two parts, its compressor pressure (scavenging pressure) is low, perhaps 1-2 bar. (in the Z4-engine high), the gas exchange occurs at the bottom dead centre of the piston (in the Z4-engine close to the top dead centre), the gas exchange occurs through grooves in the piston shaft (in the Z4-engine through a valve). The side force of the piston is compensated by means of two adjacent crank shafts, when the connecting rod angle becomes wide (in the Z4-engine two crank shafts one after the other, small connecting rod angle). The shaft of the piston must be tightened against the high combustion pressure and temperature (this is not the case in the Z4-engine).

The EP-patent application 499741 deals with the fuel injection system for combustion engine, having an assistance combustion chamber and a mean combustion chamber. The patent application deals anyhow not with the engine side, when again the Z4 patent application deals with it.

In the engine according the DEC 2703316 publication there is a separate compressor piston and a work piston, moving so that the compressor piston moves on the average 10-15 crank shaft angle in advance compared with the work piston or about 90 crank shaft angle after it (in the Z4-engine the phase shift is 0° and 180° ). It has a heat insulation in the upper part of the cylinder, at the top of the piston and in the gas exchange duct (this is not the case in the Z4-engine, where the control of the compressed air is possible, so also the cooling when wanted), and there is a heat exchanger from the exhaust gases in the gas exchange duct, it has the fuel- and air mixture in layers (this is not the case in Z4-engine) and at least one swirl chamber (this is not the case in the Z4-engine). It differ totally from the Z4-engine.

U.S. Pat. No. 5,505,172 deals with 2-stroke engine having two separate gas mixtures, the rest of the exhaust gases in the cylinder and on the other hand the new to the cylinder entered mixture, which then shall be ignited. This deals not with the Z4-engine.

EP 0779421 A1 deals with the removing of the side force of the piston by means of crank shafts, synchronized with bevel gears and with especially short connecting rods (in the Z4-engine there is a spur gear wheel gearing and connecting rods having a normal length or a normal crank mechanism). In the engine there is a “tandem” cylinder (don't deal with the Z4-engine). It deals in this case with a totally different solution. There is a little bit similar solution in the patent U.S. Pat. No. 1,193,993 (don't deal with the Z4-engine).

In the engine, according U.S. Pat. No. 5,857,436 there is a compressor- and work piston pair, moving synchronous and a connecting duct, which connects those and is equipped with a heat exchanger. The volume of the connecting duct is equal to the delivery of one stroke of the compressor piston (the Z4-engine don't take a stand on volume of the middle duct). The gas exchange occurs at the top dead centre of the piston, at 0-volume (in the Z4-engine close to the top dead centre of the piston and is followed by (secondary compression). Fully different than the Z4-engine.

U.S. Pat. No. 3,623,463 deals with equal type of solution as the previous patent. Not related with the Z4-engine.

The U.S. Pat. No. 3,880,126 (Jun. 29, 1975) deals with an engine having a spark ignition, consisting of cylinder head pairs, equipped with a normal crank mechanism. The cylinder- cylinder head pairs have in their common cylinder head a connecting duct between the compressor cylinder and the work cylinder. The exhaust valve closes early “enough” in order that a relatively big volume of exhaust gases remains in the work cylinder, according to the text 50% or even over. Behind this is the aim to keep the gases in the cylinder and the surfaces of the cylinder and the piston as hot as possible, in order to have the HC-emission to remain low. The gas exchange pressure is according to the explanation low, perhaps 1-2 bar. The gas exchange angle is wide, over 90° and the gas exchange starts quite early, about 90° after the bottom dead centre, according to the explanation. The secondary compression ration has been limited to be quite low, as the engine runs with gasoline or an other fuel equal to it, equipped with spark ignition and hot, large amount of the rest gas rises the temperature remarkable, causing the danger of knock. The transport duct, having a quite large volume between the compressor cylinder and the work cylinder limits also the compression ration. The delivery ratio of the compressor piston is quite poor, because of the construction. It is not allowed to the exhaust gases, remained into the cylinder and to the fresh mixture to blend much with each others, otherwise there is a problem with the ignition. The referred engine works so according to a fully different principle than the Z4-engine, where it is possible to control the temperature of the compressed air (so, when wanted, to cool as well).

The for the Z4-engine typical gas exchange during a small crank angle before the top dead centre and the possibility to control the temperature of the compressed gas (so also the possibility to cool) is not treated in none of these patent publications. Also the mechanical solutions are totally different. In almost of all the before mentioned publications, which were dealing with the gas exchange, it was performed, when the piston was without any movement at the top dead centre and when the cylinder volume was zero or at its minimum. Thus there was an attempt to avoid the “unnecessary” expansion when the compressed gas was moving from the compressor cylinder to the work cylinder. This is not the case in the Z4-engine. In it one part of the compression work is offered during the gas exchange, but thus the much better total efficiency is anyhow achieved. The matter becomes clear with a computer simulation. In the Z4-engine the gas exchange is performed during a small crank angle before the top dead centre, close to it. After this the upwards moving piston compresses the gas, in other words, the so called secondary compression occurs. This secondary compression is a necessity in order to achieve a high efficiency as well as the control possibility (so also the possibility to cool) of the temperature of the compressed air. Even some of these for the Z4-engine very important occurrences are not existing in any of the above mentioned patents. Also the mechanical solutions, represented in the before mentioned publications, differ totally from the mechanical solution of the Z4-engine, seen on the enclosed pictures, as well as even the gas exchange also.

The enclosed Z4-engine, pictures 1-5, is based on the combination of 2- and 4-stroke work cycles and on an isolated compressor part, which can be also for example a screw compressor, if a normal crank mechanism is used and on the leading of the new mixture to the cylinder, close at the top dead centre of the piston, at every rotation of the crank shaft, during a small crank angle, pictures 4 and 5. When the gas exchange occurs according to the pictures 4-5, work shall be gain at every rotation of the crank shaft. This increases the mechanical efficiency of the machine. Thus also the wear of the piston decreases essentially. Also the possibility to the “intern” recirculation of the exhaust gases follows from this (pictures 4 and 5). The exhaust valve is open about 180°.

The inertia forces of the valve mechanism are proportional to the masses and to the power of two of the speed of revolution and the needed gas exchange crank shaft angle to the power of two of the concerned inverse ration. The input valve can be especially small, as the pressure of the changed gas is high (for example 20 bar) and its volume by that means small. Thus the needed opening distance of the valve is small, which helps the bringing of the new gas into the cylinder, which happens during a small crank angel.

The fuel shall be injected to the compressed hot air.

The delivery volume of the compressor can be different from that value of the work cylinders together, so thus the expansion can be optimised.

In order to achieve a high mechanical efficiency, the work pistons and the compressor piston are in the same line, connected to each others, when the final net power comes to the crank mechanism. In the crank mechanism there are two to different directions rotating crank shafts, being connected to each others with a gear shaft and with auxiliary gear wheels (enclosed pictures). There are two connecting rods, where upon the side force of the piston disappears. This new type of the crank mechanism enables at the same time also the balancing of the mass forces of the 1 order (pictures 1-3). Also a normal crank mechanism is possible. In this case the isolated compressor part can also be for example a screw compressor.

The fuel shall ignite or it shall be ignited (for example glow plug, injection of the assistant fuel, spark etc.). A typical work cycle appears from the pictures 1 and 4 and 5. If a separate ignition fuel is used, it can be injected to the gas exchange duct, equipped with lamellas, parallel with the stream. Also all the fuel can be injected only to the gas exchange duct.

In the engine, there can be a heat exchanger in the gas stream. Thus the temperature of the compressed gas can be controlled (for example lower).

The patent claims:

1. A combustion engine, having an exhaust valve and a valve for the new gas coming to the cylinder (scavenging valve), each cylinder produces work at each rotation of the crank shaft, the compressor part is differentiated from the work part, after the compressor part the gas goes to the gas exchange ducts, the fuel ignites or shall be ignited (glow plug, injection of the assistant fuel, spark and so on), the exhaust gases exit through the exhaust valve,
characterized in that the scavenging gas has a high pressure (for example 20 bar), the temperature of the compressed gas can be controlled (for example lower when needed), the exhaust gas exit through the exhaust valve during about 180° crank angle, the gas exchange occurs during a small crank angle, close to the top dead centre of the piston (measured in distance), before it, as the pictures 4 and 5 shows, in other word, the gas exchange has occurred before the piston has reached its top dead centre, then the secondary compression, the self ignition of the mixture, and or the ignition and then the expansion. The size of the combustion chamber is adjustable, when needed. The fuel shall be injected to the hot compressed air.

2. Combustion engine in accordance with the patent claim 1, characterized in that it has the crank mechanism according to pictures 1-3, for the remove of the side force of the piston and the compressor part, the fuel shall be injected to the cylinder.

3. Combustion engine in accordance with the patent claim 1 characterized in that it has a normal crank mechanism and an isolated compressor part, for example a screw compressor, the fuel shall be injected to the cylinder.

4. Combustion engine in accordance with the patent claim 1, characterized in that it has according to the pictures 1-3 a crank mechanism, which removes the side force of the piston and an insulated compressor part, for example a screw compressor, the fuel shall be injected to the cylinder.

5. Combustion engine in accordance with the patent claims 1 and 2, characterized in that it has the injection of the ignition fuel.

6. Combustion engine in accordance with the patent claims 1 and 3, characterized in that it has the injection of the ignition fuel.

7. Combustion engine in accordance with the patent claims 1 and 4, characterized in that it has the injection of the ignition fuel to the gas exchange duct.

8. Combustion engine in accordance with the patent claim 1, characterized in that it has a crank mechanism, removing the side force of the piston and a compressor part, according to the pictures 1-3, the fuel is injected only to the gas exchange duct, when needed, the ignition fuel shall be injected to the hot air in the combustion chamber.

9. Combustion engine in accordance with the patent claim 1, characterized in that it has a normal crank mechanism and an insulated compressor part, for example a screw compressor and the fuel shall be injected to the gas exchange duct, the needed ignition fuel shall be injected to the hot air in the combustion chamber.

10. Combustion engine in accordance with the patent claim 1, characterized in that it has a crank mechanism, removing the side force of the piston, according to the pictures 1-3 and an insulated compressor part, for example a screw compressor and the fuel shall be injected to the gas exchange duct, the ignition fuel shall be injected when needed to the hot air in the combustion chamber.
